(19) United States
(12) Patent Application Publication
(10) Pub. No.: US 2005/0194727 A1
(43) Pub. Date: Sep. 8, 2005

(54) Length-adjustable gas spring and gas injection method

(76) Inventor: Euihyup Chung, Chungchungbookdo (KR)

Correspondence Address: LADAS & PARRY LLP, 224 SOUTH MICHIGAN AVENUE, SUITE 1600, CHICAGO, IL, 60604, US

(21) Appl. No.: 11/069,820

(22) Filed: Feb. 28, 2005

(30) Foreign Application Priority Data
Feb. 26, 2004 (KR) 10/2004-0013020

(51) Int. Cl. F16F 9/00

(52) U.S. Cl. 267/118; 267/64.11

(57) ABSTRACT

The length-adjustable gas cylinder is disclosed, which includes a cylinder that reciprocates in an inner through hole of a slide member of an outer container; a push bar and a push support that are installed at an upper side of the interior of the cylinder for performing a gas sealing and an opening and closing operation of the gas flow path; a gas flow path pipe that is fixedly inserted into the lower side of the push bar and performs a role of the path communicated so that the gases of the chambers X and Y communicate and has a gas flow hole capable of determining the maximum move-up distance of the cylinder; an integral piston assembly integrally formed with the piston part and the piston rod part; and a clip formed of a synthetic resin that fixes the piston rod part.

### TECHNICAL FIELD

The present invention relates to a length-adjustable gas spring and a gas injection method, and in particular to a length-adjustable gas spring and a gas injection method wherein there are provided a push bar of which part is protruded from an outer upper end of a cylinder, a push support for obtaining a gas sealing by inserting an o-ring from an outer and inner side wherein the push bar is inserted into a center portion of the same, a gas flow path pipe that is fixedly inserted into a lower side of a center protrusion bar of the push bar, a press bushing that is inserted into the gas flow path pipe in order to prevent the escapes of the push bar and the gas flow path pipe, a piston assembly that has a central through hole in the inner center of a piston part and the interior of a piston rod part in order for the gas flow path pipe to be inserted thereinto, and a clip that is formed of a synthetic resin capable of fixing the lower sides of a gas sealing port and a piston rod part of a gas leakage prevention elastic member at a lower side of the central through hole of the piston rod part.

### BACKGROUND ART

A length-adjustable gas spring is a major part in a chair for adjusting the seated height. According to a valve system in the Korean utility model application number 20-0308585, in a structure of a chair height-adjusting gas cylinder, an o-ring is provided at an outer surface, and a gas chamber is formed in an upper side of the same. A washer plate is sealingly engaged with an upper opened end of the cylinder member. The washer plate is pressed and fixed by a bending of an upper end of the cylinder member. The lower end of the cylinder member surrounds a bearing rotation unit during a descending operation in a distanced state by a certain width and is extended. A ring groove is formed along a surrounding portion of the inner upper side of the extended part. A c-shaped engaging ring is elastically engaged at the ring groove in order to prevent the down movements of the sealing gas chamber and the support member adapted to support the gas chamber and is air-tightly engaged. A metal pipe is integrally formed in the interior of an outer container for reinforcing the strength.

According to the laid-open number 20-0301431 of the above patent, there is provided a valve body in which a guide hole is formed at a center in an axial direction and has a step shape and is expanded in a downward direction, and a step shoulder having a plurality of o-ring insertion grooves is formed in such a manner that an inner and outer cylinder is fixed with a certain distanced space at an upper and lower side of an outer surface with respect to a flow path hole, and an engaging hole is formed along an inner surface of a lower opened end of the guide hole. There is further provided a holder in which it is installed at a guide hole of the valve body, and a fixed state is maintained by an o-ring of an upper and lower side, and a pin hole is formed at the center of the same in an axial direction, and a gas storing chamber is formed at an outer surface along a circumferential portion, and a gas flow hole communicates with an outer surface of the gas storing chamber and the pin hole. There is further provided an engaging member in which a pin hole is formed at the center in an axial direction, and an engaging protrusion is inserted into a lower side opened end of the valve body at an outer rim portion and is elastically engaged with the engaging groove and is outwardly protruded, and the engaging member closely contacts with the o-ring supporting the lower side of the holder and is tightly engaged. There is further provided a valve pin in which the engaging member, holder and valve body sequentially pass through the same, and a head part is tightly engaged with a lower side concave portion of the engaging member, and the gas passed through the gas flow hole communicates through the pin hole of the engaging member at the outer intermediate surface during the descending operation, and a gas flow groove 420 is formed at a surrounding portion for opening and closing the gas flow path during the ascending and descending operations.

The conventional length-adjustable gas spring is formed in a double type cylinder structure formed of an inner cylinder 44a and an outer cylinder 10a, and many parts are provided in the interior of the outer cylinder 10a. The above construction will be described in detail with reference to the accompanying drawings.

FIG. 1 is a vertical cross sectional view illustrating a conventional length-adjustable gas spring, and FIG. 2 is a cross sectional view illustrating a conventional valve assembly structure and a gas opening and closing pin, and FIG. 3 is an enlarged cross sectional view illustrating a piston assembly of an operation state of a conventional length-adjustable gas spring.

As shown in FIG. 1, the conventional length-adjustable gas spring includes a rod shaped outer cylinder 10a, an inner cylinder 44a installed in the interior of the outer cylinder 10a, an outer container 20a in which the outer cylinder is inserted, a slide member 52a inserted into the interior of the outer container, a piston rod part 30a fixed at a spindle support 50a of the lower side of the outer container, a piston part in which a ring 88a, a two-step washer 85a, and a piston 80a are sequentially assembled at a groove of the upper side of the piston rod part 30a. An anti-vibration rubber 62a, a trust bearing 60a and a washer 63a are assembled at the lower side of the piston rod part 30a. An end portion of the lower side of the piston rod part is assembled with the spindle support 50a of the outer cylinder and is fixed using a clip 70a formed of a steel spring.

As shown in FIG. 1, in the conventional length-adjustable gas spring, when the push rod 14a engaged to the upper most portion of the outer cylinder 10a is pressed, the push rod 14a pressed the gas opening and closing pin 100a abutting with the push rod 14a. A small diameter part 102a positioned at an intermediate portion of the gas opening and closing pin 100a is moved down, so that a space part 45a and a chamber A are opened. At this time, the space part 45a communicates with the gas flow path hole 46a, so that the gas of the chamber C is moved in the direction of the chamber A. Since the lower end of the piston rod part 30a is fixed to the spindle support 50a of the outer container 20a, the outer cylinder 10a is moved up by the counter reaction.

When the force pressing the push rod 14a is removed, the small diameter part 102a of the gas opening and closing pin 100a is moved up, so that the space part 45a and the chamber A are closed, and the outer cylinder 10a stops moving up.

In a state that the push rod 14a assembled to the upper most portion of the outer cylinder 10a is continuously pressed, the outer cylinder 10a continues to rise, and the two-step washer 85a of the lower side of the piston part 80a contacts with a cylinder cover 86a, so that the rising operation is stopped. A metal two-step washer 85a collides with a rigid cylinder cover 86a for thereby generating a strong impact, so that the cylinder stops quickly.

As shown in FIG. 2, the conventional valve assembly 40a is generally formed in a circular column shape and forms a valve inner circumference hole 43a at the center portion wherein the gas opening and closing pin 100a is inserted into the hole 43a. An o-ring is inserted into the o-ring groove 41a of the outer side for a sealing operation.

A space part 45a is formed at an inner center of the valve assembly 40a for movement of the gas. At least two o-rings 51a are provided in the space part 45a for a sealing operation. In addition, an inner side holder 55a is installed at the space part 45a for a certain interval of the o-ring 51a and a smooth sliding operation of the gas opening and closing pin 100a. A fine hole is formed at one side of the inner side holder 55a and communicates with the gas flow path hole 46a.

As shown in FIGS. 3 and 4, the piston part 80a and the piston rod part 30a will be described. The piston part 80a and the piston rod part 30a are separate parts. The piston rod part 30a is fabricated in such a manner that the processing step for processing a metallic rod in a certain shape and the surface polishing process of smoothing the surface of the non-uniform metallic rod are performed two or three times, and then the chrome coating process is performed in order to prevented the surface of the metallic surface from getting rusted. The piston rod part includes a ring 88a, a two-step washer 85a, a piston 80a, a piston outer side ring 82a, and a piston inner side o-ring 81a. A certain groove is formed at an upper portion of the piston rod 30a, and it is mounted thereon. A two-step washer 85a is fixed in order to prevent an escape of the piston in a downward direction. An o-ring is inserted into the inner and outer sides. A piston capable of preventing a gas flow between the chambers X and Y is assembled. The piston is fixed at the piston rod based on a riveting work in order to prevent the piston from being escaped from the piston rod.

In the conventional method of injecting a high pressure into the interior of the cylinder, a high pressure gas is forced from the outside of the cylinder through a space formed between the outer diameter surface of the piston rod 30a and the inner diameter of the rod guide 83a. An inner diameter seal lip formed of an elastic material of the rod seal 84a is widened based on a gas pressure difference between a high gas pressure of the outside of the cylinder and a low gas pressure in the interior of the cylinder, so that a communication space is formed between the outer diameter surface of the piston rod part 30a and the inner diameter seal lip of the rod seal 84a, whereby the interior of the cylinder communicates with the outside of the cylinder. A high pressure gas of the outside of the cylinder is injected into the interior of the cylinder through a communicating space. A gas pressure injected into the interior of the cylinder based on the conventional method is non-uniform due to a hardness of the rod seal.

The structure of the conventional length-adjustable gas spring is complicated. Many parts are adapted. The quality of the product is not uniform. The fabrication cost is increased.

### DISCLOSURE OF INVENTION

Accordingly, it is an object of the present invention to overcome the problems encountered in the conventional art.

It is another object of the present invention to provide a length-adjustable gas spring that is obtained by improving the structure of the conventional length-adjustable gas spring of the Korean patent application numbers 10-2002-0054651, 10-2003-0013162, and the Korean utility model application number 314279 filed by the same applicant as the present invention. There are provided a cylinder 30 that moves down and up in the inner through hole of a slide member 140 of an outer container 120; a push bar 40 and a push support 50 that are installed at an upper side of the interior of the cylinder for performing a gas sealing and an opening and closing operation of the gas flow path; a gas flow path pipe 70 that is fixedly inserted into the lower side of the push bar 40 and performs a role of the path communicated so that the gases of the chambers X and Y communicate and has a gas flow hole 73 capable of determining the maximum move-up distance of the cylinder 30; an integral piston assembly 90 integrally formed with the piston part 81 and the piston rod part 91; and a clip 160 formed of a synthetic resin that fixes the piston rod part 91. The innovative product is provided. The quality of the product is enhanced. The fabrication cost is decreased, and the productivity is increased.

To achieve the above objects, there is provided a length-adjustable gas cylinder that includes a cylinder 30 that reciprocates in an inner through hole of a slide member 140 of an outer container 120; a push bar 40 and a push support 50 that are installed at an upper side of the interior of the cylinder for performing a gas sealing and an opening and closing operation of the gas flow path; a gas flow path pipe 70 that is fixedly inserted into the lower side of the push bar 40 and performs a role of the path communicated so that the gases of the chambers X and Y communicate and has a gas flow hole 73 capable of determining the maximum move-up distance of the cylinder 30; an integral piston assembly 90 integrally formed with the piston part 81 and the piston rod part 91; and a clip 160 formed of a synthetic resin that fixes the piston rod part 91.

In the present invention, the construction of product is simplified, and the number of parts is decreased, and the quality of the products is enhanced for thereby increasing productivity. A high pressure gas is forced from the outside of the cylinder 30 into the interior of the cylinder through an inner central through hole 96 and a lower side central through hole 99 that are formed at the inner center portion of the piston assembly 90, so that it is possible to inject a uniform pressure gas into the interior of the cylinder.

### BRIEF DESCRIPTION OF DRAWINGS

The preferred embodiments of the present invention will be described with reference to the accompanying drawings.

FIG. 1 is a vertical cross sectional view illustrating a conventional length-adjustable gas spring;

FIG. 2 is a cross sectional view illustrating a valve assembly in a conventional length-adjustable gas spring;

FIG. 3 is a cross sectional view illustrating a piston assembly in a conventional length-adjustable gas spring;

FIG. 4 is a vertical cross sectional view illustrating a length-adjustable gas spring according to the present invention;

FIG. 5 is a vertical cross sectional view when a length-adjustable gas spring is risen according to the present invention;

FIG. 6 is a detailed view illustrating an assembly of a push support and a push bar according to the present invention;

FIG. 7 is a cross sectional view illustrating a push support according to the present invention;

FIG. 8 is a cross sectional view illustrating a push bar according to the present invention;

FIG. 9 is a cross sectional view illustrating a press bushing according to the present invention;

FIG. 10 is a cross sectional view illustrating a gas flow path pipe according to the present invention;

FIG. 11 is a detailed view illustrating a piston part according to the present invention;

FIG. 12 is a cross sectional view illustrating a piston rod part according to the present invention;

FIG. 13 is a detailed view illustrating an assembled state of a piston assembly according to the present invention;

FIG. 14 is a cross sectional view illustrating a rod guide according to the present invention;

FIG. 15 is a cross sectional view illustrating a rod support member according to the present invention; and

FIG. 16 is a cross sectional view illustrating a clip according to the present invention.

### BEST MODE FOR CARRYING OUT THE INVENTION

The present invention will be described with reference to the accompanying drawings.

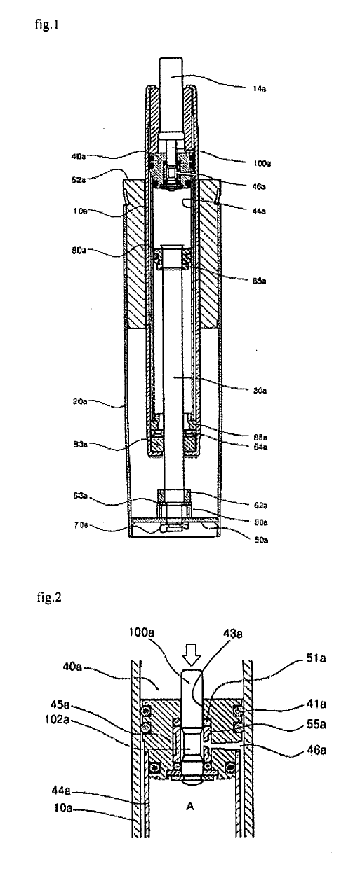

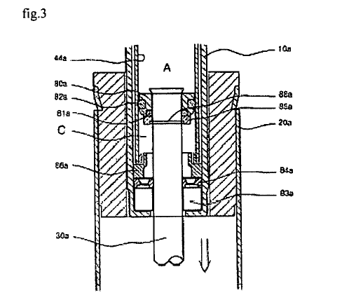

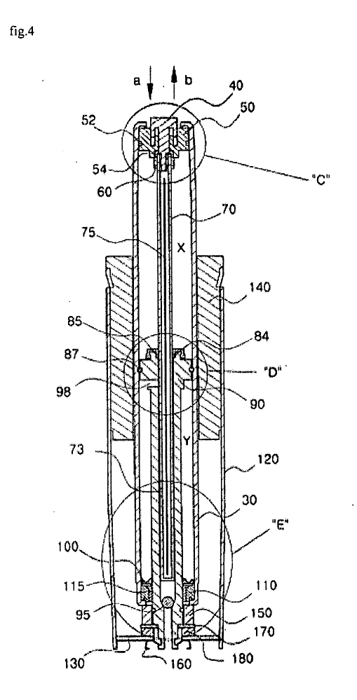

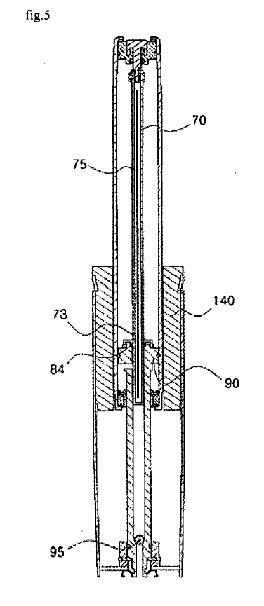

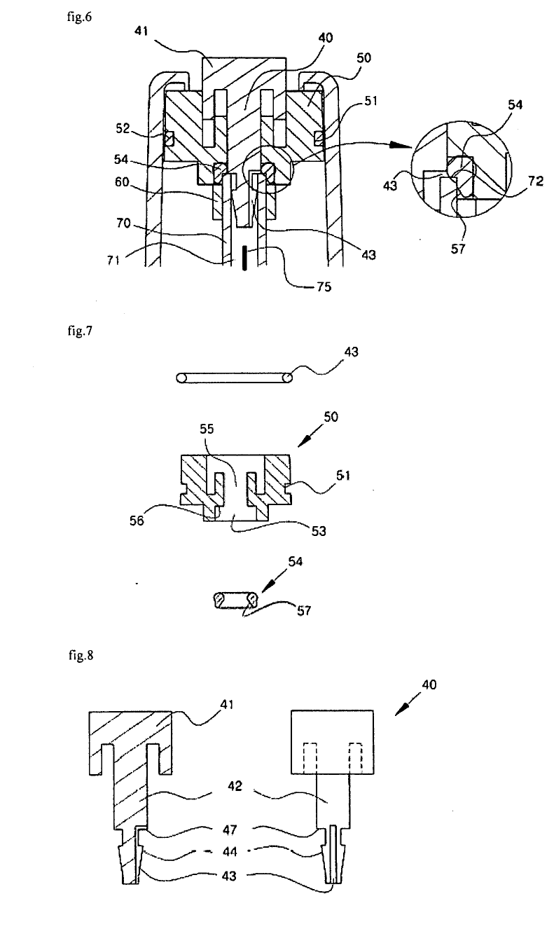

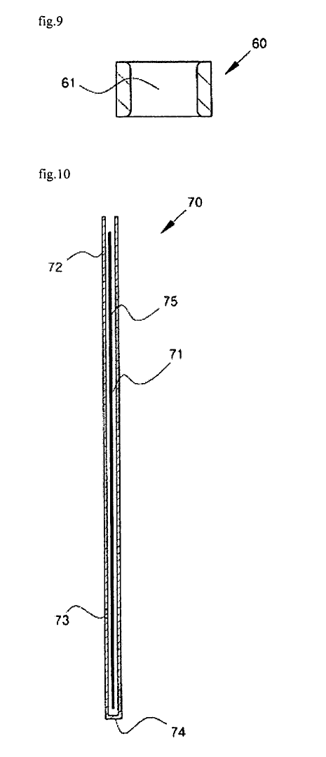

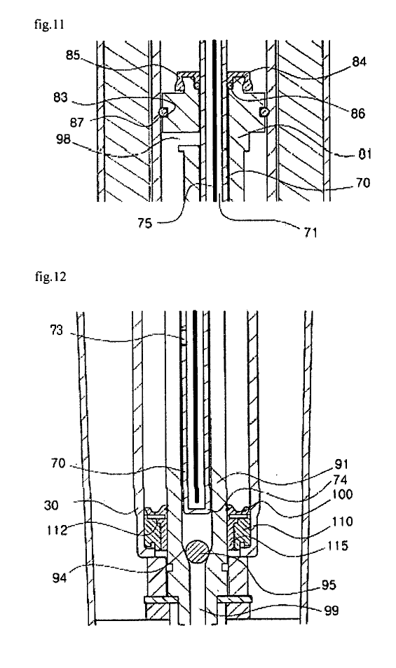

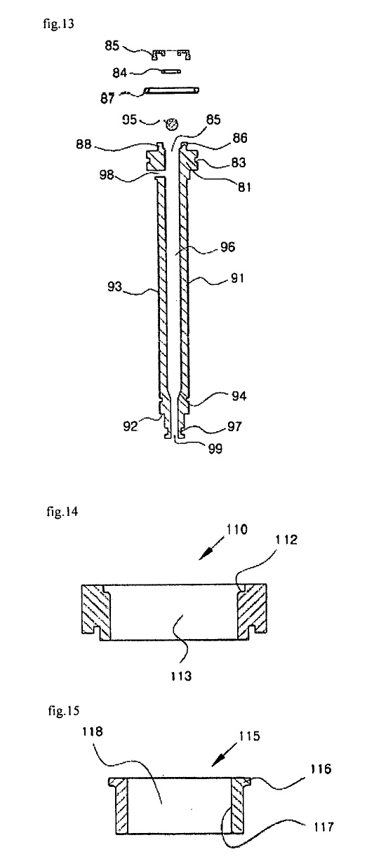

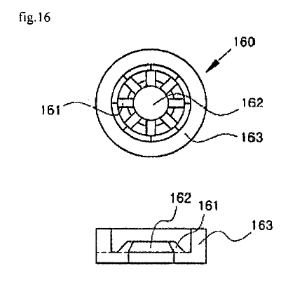

FIG. 1 is a vertical cross sectional view illustrating a conventional length-adjustable gas spring; FIG. 2 is a cross sectional view illustrating a valve assembly in a conventional length-adjustable gas spring; FIG. 3 is a cross sectional view illustrating a piston assembly in a conventional length-adjustable gas spring; FIG. 4 is a vertical cross sectional view illustrating a length-adjustable gas spring according to the present invention; FIG. 5 is a vertical cross sectional view when a length-adjustable gas spring is risen according to the present invention; FIG. 6 is a detailed view illustrating an assembly of a push support and a push bar according to the present invention; FIG. 7 is a cross sectional view illustrating a push support according to the present invention; FIG. 8 is a cross sectional view illustrating a push bar according to the present invention; FIG. 9 is a cross sectional view illustrating a press bushing according to the present invention; FIG. 10 is a cross sectional view illustrating a gas flow path pipe according to the present invention; FIG. 11 is a detailed view illustrating a piston part according to the present invention; FIG. 12 is a cross sectional view illustrating a piston rod part according to the present invention; FIG. 13 is a detailed view illustrating an assembled state of a piston assembly according to the present invention; FIG. 14 is a cross sectional view illustrating a rod guide according to the present invention; FIG. 15 is a cross sectional view illustrating a rod support member according to the present invention; and FIG. 16 is a cross sectional view illustrating a clip according to the present invention.

As shown therein, there are provided a cylinder 30, a push bar 40, a head part 41, a circular rod part 42, a gas flow path groove 43, a protrusion part 44, a concave part 46, a boundary surface 47, an engaged protrusion part 48, a push support 50, central through holes 51, 61, 71, 96, 113 and 116, a protrusion insertion groove 52, a receiving part 53, an inner o-ring insertion groove 54, an inclined surface 55, an inner o-ring 56, an outer side groove 57, an outer side o-ring 58, a press bushing 60, a gas flow path pipe 70, an upper side end surface 72, a gas flow path hole 73, a lower side end surface 74, a metallic bar 75, a piston part 81, an outer side groove 83, an inner o-ring 84, a piston lid 85, an inner side groove 86, an outer o-ring 87, a protrusion part 88, a piston assembly 90, a piston rod part 91, a right angle step surface 92, an inclined surface 94, a gas sealing part 95, a clip insertion groove 97, a gas flow hole 98, a gas injection through hole 99, a rod seal 100, a rod guide 110, an inner side groove 112, a rod support member 115, an outer side protrusion part 116, an outer container 120, a spindle support 130, a slide member 140, an anti-vibration rubber 150, a clip 160, a protrusion 161, an inner through hole 162, an outer surface rim 163, an upper side washer 170, a plastic support washer 180, and a chamber X and a chamber Y.

FIGS. 4 and 5 are vertical cross sectional views illustrating a length-adjustable gas spring according to the present invention. The construction of the length-adjustable gas spring according to the present invention will be described with reference to the accompanying drawings.

There are provided a cylindrical outer container 120 of which upper and lower sides are opened; a spindle support 130 that is fixed at an opened lower end of the outer container 120 and has a through hole at the center of the same; a slide member 140 that is inserted into an opened upper side interior of the outer container 120 and supports the cylinder 30 that will move down and up; a cylindrical cylinder 30 that is inserted at the inner center of the slide member 140 and has opened upper and lower portions that move up and down; a push support 50 that is installed at an inner upper side of the cylinder 30 and has an o-ring for preventing a gas leakage at an outer and inner lower side and has a central through hole 51 into which the push bar 40 is inserted at the center portion of the same; a push bar 40 that is inserted into the central through hole 51 of the push support 50 and reciprocates up and down and has at least one gas flow path groove 43 at the lower side end portion for the movement of gas; a gas flow path pipe 70 that is fixedly inserted into the lower side portion of the push bar 40 and is moved up and down together with the push bar 40 and has a gas flow path hole 73 at one side of the lower portion for thereby communicating with the central inner through hole 71 in which the metallic bar 75 is inserted wherein the lower side end surface 74 of the same is closed; a press bushing 60 that is inserted into the outer diameter portion of the upper side of the gas flow path pipe 70 for thereby preventing a separation of the push bar 40 and the gas flow path pipe 70; an upper side washer 170 that is inserted into the lower side of the cylinder 30 wherein the end portion of the lower side of the same is inserted into the central through hole of the spindle support 130; a piston part 81 that is fixed by a plastic support washer 180 and a clip 160 and sections the interior of the cylinder 30 into a chamber X and a chamber Y; an integral piston rod part 91 that helps the cylinder 30 move up and down; a piston assembly 90 that has a central through hole 96 so that the gas flow path pipe 70 is inserted into the inner center portion and reciprocates and is used as a gas injection through hole 99 wherein the inner diameter of the lower side of the central through hole 96 is narrow and has a gas flow hole 98 at one side of the upper portion of the piston rod part 91 for the flow of gas; an elastic gas sealing part 95 that is inserted into the inner central through hole 96 of the piston assembly 90 and blocks the gas injection through hole 99 having a small inner diameter for thereby preventing a high pressure gas from being discharged from the interior of the cylinder 30 to the outside wherein the diameter is larger than the inner diameter of the gas injection through hole 99 and is less than the inner diameter of the central through hole 96; a piston lid 85 that is engaged to an upper side of the piston part 81 and prevents the inner side o-ring 84 from being escaped from the piston part 81 of the piston assembly 90; a rubber and elastic rod seal 100 that is inserted into the lower side of the inner portion of the cylinder 30 and performs a function of maintaining a gas sealing between the cylinder 30 and the piston rod part 91; a rod guide assembly formed based on an engagement of the rod guide 110 and the rod support member 115 at the lower side of the rod seal 100; an anti-vibration rubber 150 that is formed at a lower side of the cylinder 30 and releases the impact that occurs when the cylinder 30 is most moved down based on the weight of a user; and a clip 160 that is formed of a synthetic resin capable of fixing the piston assembly 90 inserted into the central through hole of the spindle support 130.

As shown in FIGS. 6 and 8, the push bar 40 includes a cylindrical head part 41 forming the upper side of the same; an engaging protrusion part 48 protruded from a rim of a lower surface of the head part 41; a circular rod part 42 that is protruded from a lower center of the head part 41 in a circular rod shape; a concave part 46 that is extended from a lower side of the circular rod part 42; a right angle step shaped boundary surface 47 that performs a stopper role for preventing the gas flow path pipe 70 from being moved in the direction of the upper side of the circular rod part 42 wherein the concave part 46 is less than the outer diameter of the circular rod part 42; a protrusion part 44 that is protruded from the lower side of the concave part 46 in a triangle conical shape and is forced into the inner center through hole 71 of the gas flow path pipe 70; and a gas flow path groove 43 that is extended from a lower one side of the protrusion part 44 to an upper portion of the boundary surface 47.

As shown in FIGS. 6 and 7, the push support 50 includes a central through hole 51 that is inserted into the upper inner side of the cylinder 30 and supports the push bar 40 and prevents the gas of the interior of the cylinder 30 from being leaked to the outside wherein it has a cylindrical inner central part so that the circular rod part 42 of the push bar 40 passes through the same; a receiving part 53 that is formed at an upper side of the central through hole 51 wherein the head part 41 of the push bar 40 is inserted thereinto and has a protrusion part insertion groove 52 into which the engaging protrusion part 48 of the push bar 40 is inserted; an inner side o-ring insertion groove 54 that is formed in such a manner that the surrounding portion of the central through hole 51 of the lower surface is protruded; an inner side o-ring 56 that is inserted into the inner side o-ring insertion groove 54 and has an inclined surface 55 for engaging a gas sealing force; an outer side groove 57 that is formed at a surrounding portion of the outer side surface; and an outer side o-ring 58 that is inserted into the outer side groove 57 and prevents the gas of the interior of the cylinder from being leaked to the outside.

Here, the inner side o-ring 56 prevents the gas from being leaked from the chamber X that is the inner space of the cylinder 30 to the outside of the cylinder and opens and closes the gas flow path groove 43 by separating or closely engaging with the upper side end surface 72 of the gas flow path pipe 70. In particular, the inner side o-ring 56 has an inclined surface 55 for closely contacting with the upper side end surface 72 of the gas flow path pipe 70 for thereby efficiently sealing the gas of the chambers X and Y As shown in FIGS. 6 and 9, the press bushing 60 is formed in a ring shape and has a central through hole 61 having the same size as the outer diameter of the gas flow path pipe 70 at the center portion wherein the end portions of the upper and lower sides of the inner surface are rounded. The press bushing 60 is inserted into the upper outer side of the gas flow path pipe 70 so that the triangle conical shaped protrusion part 44 closely contacts with the inner diameter surface of the inner central through hole 71 of the gas flow path pipe 70 at the lower side of the push bar 40 for thereby preventing the gas flow path pipe 70 from being escaped from the circular rod part 42 of the push bar 40.

As shown in FIG. 10, in the gas flow path pipe 70, the inner diameter of the inner central through hole 71 is larger than the outer diameter of the concave part 46 of the push bar 40 and is less than the outer diameter of the circular rod part 42 of the push bar 40. The outer diameter of the gas flow path pipe 70 is smaller than the central through hole 96 of the piston assembly 90. The end surface of the upper side is opened, and the end surface 74 of the lower side is closed. A gas flow path hole 73 is formed at an upper side of the lower side end surface 74. A cylindrical pipe having a metallic bar therein in a straight line shape is formed at the central through hole 71.

As shown in FIGS. 11 through 13, in the piston assembly 90, the piston part 81 and the piston rod part 91 are integrally injection-molded using an engineering plastic. The gas flow path pipe 70 is installed at the inner center portions of the piston part 81 and the piston rod part 91 and reciprocates in the central through hole 96. The smaller inner diameter portion is formed at the lower side of the central through hole 96 and is used as the gas injection through hole 99. A gas flow hole 98 is formed at one side of the upper portion of the piston rod part 91.

The piston part 81 includes an outer side groove 83 that is formed in a cylindrical shape and has the same diameter as the inner diameter of the cylinder 30 and is formed at a central portion of the outer surface; an elastic outer o-ring 87 that is inserted into the outer side groove 83 and has a gas sealing function between the chambers X and Y; a protrusion part 88 that is formed at one side of the upper rim portion of the central through hole 96; an inner side groove 86 formed by the protrusion part 88; an inner o-ring 84 that is inserted into the inner side groove 86 and has a gas sealing function; and a piston lid 85 that is engaged to the upper side of the protrusion part 88 and prevents an escape of the inner side o-ring 84. The interior of the cylinder 30 is divided into the chambers X and Y When the cylinder 30 moves up, the gas passes through the inner o-ring 84 capable of performing the gas sealing function in such a manner that the gas flow hole 73 of the gas flow path pipe 70 is inserted into the inner side groove 86 of the piston part 81. At the time when the gas is inserted into the interior of the chamber X, the gas flow path is closed, and the cylinder 30 stops moving-up.

The piston rod part 91 includes a central through hole 96 that is integrally formed with the lower side of the piston part 81 and is longitudinally formed in a cylindrical shape and is formed at the inner center portion and receives a gas flow path pipe 70 therein; a gas injection through hole 99 of which inner diameter is smaller at the lower side of the central through hole 96, an inclined surface 94 that is formed at the boundary between the central through hole 96 and the gas injection hole 99, a gas flow hole 98 that is formed at an upper one side wherein gas flows therein; and a clip insertion groove 97 that is formed at an outer surface of the end portion of the lower side. The end portion of the lower side having the clip insertion groove 97 has a smaller inner diameter for thereby being inserted into the central through hole of the spindle support 130, so that the right angle step surface 92 is formed.

The bending of the piston rod part and the non-uniformity of the outer diameter of the rod part when the piston assembly 90 is injection-molded are prevented in such a manner that the central through hole 96 and the gas injection through hole 99 passing through the entire inner portions of the piston assembly 90 are formed at the inner center portion of the piston assembly 90. The non-uniform injection of the gas into the interior of the cylinder is prevented in such a manner that a high pressure gas is injected from the outside of the cylinder 30 into the interior of the cylinder through the gas injection through hole 99 of the piston rod part 91.

As shown in FIGS. 14 and 15, the rod guide assembly is constructed based on the engagement of a rod guide 110 and a rod support member 115.

The rod guide 110 is formed of a rigid material for being supported against a high pressure gas in the interior of the cylinder and includes a central through hole 113 formed at a center inner side in a cylindrical shape wherein the rod support member 115 is inserted thereinto, and an inner side groove 112 that is formed at an end rim portion of the upper side of the central through hole 113.

Here, the rod support member 115 is inserted into the central through hole 113 of the rod guide 110 and is formed of a certain material smoother than the material of the piston rod part 91 so that scratches and damages are not generated at the outer diameter surface 93 of the piston rod part 91 during the up and down movements and includes a central through hole 118 into which the piston rod part 91 of the piston assembly 90 is inserted at the central inner side, and an outer side protrusion part 116 that is protruded from the upper side in a circular shape and is mounted on the inner side groove 112 of the rod support member 110.

The rod seal 100 and the rod guide assembly are inserted into the interior of the cylinder 30 through the lower side of the piston rod part 91. The rod seal 100 is adapted to prevent a high pressure gas from being leaked from the interior of the cylinder 30 to the outside of the cylinder. Here, the rod guide assembly supports the piston rod part 91 and allows the rod seal 100 to resist with respect to a high pressure gas in the interior of the cylinder. The anti-vibration rubber 150 inserted into the lower outer side of the cylinder is designed to absorb the impact generated when it is moved in the lower direction of the cylinder.

As shown in FIGS. 4 and 16, the clip 160 is formed of a synthetic resin based on the injection molding method and includes a central through hole 162 formed so that a lower end of the piston rod part 91 passes through the central through hole 162, a protrusion 161 that is divided into multiple parts along an inner surface of the central through hole 162 and has a certain inclination in the direction of the center of the inner side through hole with a certain elastic force and is fixedly inserted into the clip insertion groove 97 of the piston rod part 91, and an outer surface rim 163 that performs a reinforcing role capable of supporting the protrusion 161.

In the gas injection method into the interior of the cylinder 30 according to the present invention, a high pressure gas is forced into the chambers X and Y from the outside of the cylinder 30 that remains in the same gas pressure state as the atmospheric state. The push bar 40 is pushed down in a downward direction “a” so that the inclined surface 55 of the inner side o-ring 56 is separated from the upper side end surface 72 of the gas flow path pipe 70 in a state that the gas pressure state in the chambers X and Y is the same as the atmospheric state, so that the gas flow path groove 43 allows a communication between the inner central through hole 71 of the gas flow path pipe 70 and the chamber X. When a high pressure gas is forced into the interior of the cylinder 30 from the outside of the cylinder 30 through the gas injection through hole 99 of the piston rod part 91, the gas sealing part 95 is moved toward the lower side end surface 74 of the gas flow path pipe 70 of the piston rod part 91 by a high pressure gas and stops. The gas injection through hole 99 is communicated with the central through hole 96, and the central through hole 96 is communicated with the chamber Y through the gas flow hole 98 formed at the boundary between the piston part 81 and the piston rod part 91, so that a high pressure gas is injected into the chamber Y of the interior of the cylinder based on a pressure difference between the gas pressure of the interior of the cylinder and the pressure of the gas injected from the outside of the cylinder 30. The gas injected into the interior of the piston rod part 91 through the gas injection through hole 99 is inputted into the inner central through hole 71 of the gas flow path pipe 70 through the gas flow path hole 73 of the gas flow path pipe 70 and is moved in the upward direction and then is injected into the chamber X through the gas flow path groove 43 formed at the push bar 40. When the gas pressure of the interior of the cylinder reaches at a certain pressure, the supply of the high pressure gas forced from the outside of the cylinder is stopped. Upon stopping the supply of the gas, the gas sealing part 95 inserted into the inner central through hole 96 of the piston assembly 90 is tightly contacted with the inclined surface 94 formed at the inner central through hole of the piston rod part 91 based on a high pressure gas in the interior of the cylinder 30, so that it is possible to prevent a high pressure gas in the interior of the cylinder from being leaked, whereby the gas injection into the interior of the cylinder 30 is completed.

In the conventional method of injecting a high pressure gas into the interior of the cylinder, a high pressure gas is forced into the interior of the cylinder from the outside of the cylinder through a space formed between the outer diameter surface of the piston rod 30a and the rod guide 83a. In this case, the inner diameter seal lip formed of an elastic material of the rod seal is widened due to a difference between a high pressure gas of the outside of the cylinder and a low pressure gas of the interior of the cylinder, so that a certain communication space is formed between the outer diameter surface of the piston rod part 30a and the inner diameter seal lip of the rod seal 84a, resulting in a communication between the interior of the cylinder and the outside of the cylinder. Therefore, a high pressure gas of the outside of the cylinder is injected into the interior of the cylinder through the communicating space, so that a non-uniform pressure of gas is injected into the interior of the cylinder based on a non-uniform hardness of the rod seal and through a non-uniform space formed between the outer diameter surface of the piston rod 30a and the inner diameter of the rod guide 83a.

However, in the present invention, a high pressure gas is concurrently inputted into the chambers X and Y through the lower side central through hole 99 of the end portion of the piston rod part 91 in a state that the chambers X and Y are communicated through the gas flow hole 98 of the piston assembly 90, the inner central through hole 96 of the piston assembly 90, the gas path hole 73 of the gas flow path pipe 70, the inner central through hole 71 of the gas flow path pipe 70 and the gas flow path groove 43 formed from one lower side of the protrusion part 44 of the push bar 40 inserted into the inner central through hole 71 to a part of the upper side of the boundary surface 47 for thereby achieving a desired injection of uniform pressure gas.

In the present invention, the maximum upper and lower stroke distances of the cylinder are determined based on the formation position of the gas flow path hole 73 formed at the gas flow path pipe 70. The above operation will be described in detail.

Since the gas pressure in the interior of the cylinder 30 is higher than atmospheric pressure, when the push bar 40 is pressed down, the gas flow path pipe 70 connected with a lower side of the circular rod part 42 of the push bar 40 is moved down, so that the inclined surface 55 of the inner side o-ring 56 assembled to the push support 50 is separated from the upper side end surface 72 of the gas flow path pipe 70, whereby the gas flow path groove 43 formed based on an engagement of the gas flow path pipe 70 is communicated with the chamber X and the inner central through hole 96 of the piston assembly 90. Therefore, since the gas pressure of the chamber X is lower than the gas pressure of the chamber Y, the gas of the chamber Y of the lower side part of the cylinder 30 is inputted into the chamber X through the gas flow hole 98 of the piston assembly 90, the inner central through hole 96 of the piston assembly 90, the gas flow hole 73 of the gas flow path pipe 70, the inner central through hole 71 and the gas flow path groove 43 formed from one side of the lower portion of the protrusion 44 of the push bar 40 to a part of the upper side of the boundary 47. Therefore, the gas flow path pipe 70 engaged with the cylinder 30 and a lower side part of the circular rod part 42 of the push bar 40 is moved up in an upward direction “b”. The gas flow hole 73 of the gas flow path pipe 70 is inserted into the inner side groove 86 of the piston part 81 and passes through the inner o-ring 84 having a gas sealing function. At the time when it reaches at the inner side of the chamber X, a gas flow between the chambers X and Y is stopped. The movement of the cylinder 30 is smoothly stopped without any impact, so that the maximum moving-up distance of the cylinder 30 is determined based on the position of the gas flow hole 73 of the gas flow path pipe 70.

When a user seats on a chair in a state that the cylinder 30 is moved-up in maximum and then is stopped, the cylinder 30 is moved down in a downward direction “a” by the weight of the user. Therefore, the gas flow hole 73 of the gas flow path pipe 70 in the inner side of the chamber X is moved in the direction of the lower side of the inner o-ring 84 of the piston part 81 and is moved in the direction of the inner side of the inner central through hole 96 of the piston rod part 91. Since the gas pressure of the chamber X is higher than the gas pressure of the chamber Y, when the push bar 40 is pressed in the downward direction “a”, the chambers X and Y are communicated through the gas flow path, so that the gas is moved from the chamber X to the chamber Y, and the cylinder 30 is moved down in the direction “a”.

The operation method of the present invention will be described. Since the gas pressure of the interior of the cylinder 30 is higher than atmospheric pressure, when the push bar 40 is pressed down in the downward direction “a”, the gas flow path pipe 70 engaged with the lower side part of the circular rod part 42 of the push bar 40 is moved down, so that the inclined surface 55 of the inner side o-ring 56 assembled to the push support 50 is separated from the upper side end surface 72 of the gas flow path pipe 70, whereby the gas flow path groove 43 formed based on an engagement of the gas flow path pipe 70 is communicated with the chamber X and the inner central through hole 96 of the piston assembly 90. Therefore, when the gas pressure of the chamber X is lower than the gas pressure of the chamber Y, the gas of the chamber Y of the lower side part of the cylinder 30 is moved into the chamber X through the gas flow hole 98 of the piston assembly 90, the inner central through hole 96 of the piston assembly 90, the gas path hole 73 of the gas flow path pipe 70, the inner central through hole 71, and the gas flow path groove 43 formed from one lower side of the protrusion part 44 of the push bar 40 inserted into the inner central through hole 71 to a part of the upper side of the boundary surface 47. Therefore, the piston assembly 90 is moved down in the downward direction “a”. Since the lower end of the piston rod part 91 is fixed to the spindle support 130 by the clip 160, the cylinder 30 is moved up in the upward direction “b” based on the counter-reaction. On the contrary, when the gas pressure of the chamber X is higher than the gas pressure of the chamber Y, the gas of the chamber X is inputted into the chamber Y through the gas flow path groove 43 of the push bar 40, the central through hole 71 and the gas path hole 73 of the gas flow path pipe 70, the central through hole 96 of the piston assembly 90, and the gas flow hole 98 of the piston assembly 90. Therefore, the piston assembly 90 is moved in the upward direction “b”, and the lower end of the piston rod part 91 is fixed to the spindle support 130 by the clip 160, so that the cylinder 30 is moved down based on the counter-reaction in the downward direction.

Since the inner pressure of the cylinder 30 is higher than atmospheric pressure, when the force pressing the push bar 40 is removed, the push bar 40 is moved up in the upward direction “b” by the gas pressure of the chamber X of the cylinder 30, and the upper side end surface 72 of the gas flow path pipe 70 is closely contacted with the inclined surface 55 of the inner side o-ring 56, so that the gas flow path groove 43 formed based on an engagement of the gas flow path pipe 70 blocks the chamber X and the inner central through hole 96 of the piston assembly 90 and the gas flow path, so that the gas movement between the chambers X and Y is stopped, and the piston assembly 90 stops, and the movement of the cylinder 30 is stopped.

The construction of parts is simplified, and the number of parts is minimized. The gas opening and closing operation and gas movement are efficient. It is possible to seal gas and to open and close the gas flow path groove 43 using only one inner side o-ring inserted into the inner central through hole 51 of the push support 50. In a state that the push bar 40 is not pushed, the inclined part 57 of the inner side o-ring 56 keeps a desired full contact state with the upper side end surface 72 of the gas flow path pipe 70 for thereby air-tightly sealing the gas flow path groove 57 of the inner side o-ring 56. When the push bar 40 is pushed, the push bar 40 and the gas flow path pipe 70 are moved in the downward direction “a”, so that the inclined surface 55 of the inner side o-ring 56 and the upper side end surface 72 of the gas flow path pipe 70 are separated from each other, whereby the gas is moved through the gas flow path groove 43 of the push bar 40.

The valve assembly 40a and the functions of the functions of the valve support member 16a, the push rod 14a and the gas opening and closing pin 100a of the conventional art in which the parts are complicated are substituted with the simple constructions of the push support 50 and the push bar 40 in the present invention.

### INDUSTRIAL APPLICABILITY

As described above, the present invention relates to a single cylinder structure. The movement of gas is opened and closed using a push bar formed of a gas flow path groove and only one o-ring. The gas flow path pipe is inserted into the inner side central through hole of the cylinder and the piston assembly. The piston part and the piston rod part are integral for thereby forming a piston integral structure. A smooth material rod support member is inserted into the interior of the rod guide in order to remove scratches and damages of the outer diameter surface of the piston rod of the piston assembly. The maximum moving-up distance of the cylinder 30 is determined based on the position of the gas flow hole 73 of the gas flow path pipe 70. It is possible to smoothly stop the moving-up of the cylinder 30 without any impact in the cylinder when the cylinder is moved up in maximum. The clip adapted to fix the piston rod part is formed of synthetic resin, so that the assembling process is simplified. The gas injection into the interior of the cylinder is performed through the gas injection through hole of the piston rod for thereby achieving gas injection of uniform pressure. Innovative products can be fabricated, and the fabrication cost is decreased. Product competitive power is enhanced.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A length-adjustable gas spring, comprising:
a cylindrical outer container 120 of which upper and lower sides are opened;
a spindle support 130 that is fixed at an opened lower end of the outer container 120 and has a through hole at the center of the same;
a slide member 140 that is inserted into an opened upper side interior of the outer container 120 and supports the cylinder 30 that will move down and up;
a cylindrical cylinder 30 that is inserted at the inner center of the slide member 140 and has opened upper and lower portions that move up and down;
a push support 50 that is installed at an inner upper side of the cylinder 30 and has an o-ring for preventing a gas leakage at an outer and inner lower side and has a central through hole 51 into which the push bar 40 is inserted at the center portion of the same;
a push bar 40 that is inserted into the central through hole 51 of the push support 50 and reciprocates up and down and has at least one gas flow path groove 43 at the lower side end portion for the movement of gas;
a gas flow path pipe 70 that is fixedly inserted into the lower side portion of the push bar 40 and is moved up and down together with the push bar 40 and has a gas flow path hole 73 at one side of the lower portion for thereby communicating with the central inner through hole 71 in which the metallic bar 75 is inserted wherein the lower side end surface 74 of the same is closed;
a press bushing 60 that is inserted into the outer diameter portion of the upper side of the gas flow path pipe 70 for thereby preventing a separation of the push bar 40 and the gas flow path pipe 70;
an upper side washer 170 that is inserted into the lower side of the cylinder 30 wherein the end portion of the lower side of the same is inserted into the central through hole of the spindle support 130;
a piston part 81 that is fixed by a plastic support washer 180 and a clip 160 and sections the interior of the cylinder 30 into a chamber X and a chamber Y;
an integral piston rod part 91 that helps the cylinder 30 move up and down;
a piston assembly 90 that has a central through hole 96 so that the gas flow path pipe 70 is inserted into the inner center portion and reciprocates and is used as a gas injection through hole 99 wherein the inner diameter of the lower side of the central through hole 96 is narrow and has a gas flow hole 98 at one side of the upper portion of the piston rod part 91 for the flow of gas;
an elastic gas sealing part 95 that is inserted into the inner central through hole 96 of the piston assembly 90 and blocks the gas injection through hole 99 having a small inner diameter for thereby preventing a high pressure gas from being discharged from the interior of the cylinder 30 to the outside wherein the diameter is larger than the inner diameter of the gas injection through hole 99 and is less than the inner diameter of the central through hole 96;
a piston lid 85 that is engaged to an upper side of the piston part 81 and prevents the inner side o-ring 84 from being escaped from the piston part 81 of the piston assembly 90;
a rubber and elastic rod seal 100 that is inserted into the lower side of the inner portion of the cylinder 30 and performs a function of maintaining a gas sealing between the cylinder 30 and the piston rod part 91;
a rod guide assembly formed based on an engagement of the rod guide 110 and the rod support member 115 at the lower side of the rod seal 100;
an anti-vibration rubber 150 that is formed at a lower side of the cylinder 30 and releases the impact that occurs when the cylinder 30 is most moved down based on the weight of a user; and
a clip 160 that is formed of a synthetic resin capable of fixing the piston assembly 90 inserted into the central through hole of the spindle support 130.

2. The gas spring of claim 1, wherein said push bar 40 includes:
a cylindrical head part 41 forming the upper side of the same;
an engaging protrusion part 48 protruded from a rim of a lower surface of the head part 41;
a circular rod part 42 that is protruded from a lower center of the head part 41 in a circular rod shape;
a concave part 46 that is extended from a lower side of the circular rod part 42;
a right angle step shaped boundary surface 47 that performs a stopper role for preventing the gas flow path pipe 70 from being moved in the direction of the upper side of the circular rod part 42 wherein the concave part 46 is less than the outer diameter of the circular rod part 42;
a protrusion part 44 that is protruded from the lower side of the concave part 46 in a triangle conical shape and is forced into the inner center through hole 71 of the gas flow path pipe 70; and
a gas flow path groove 43 that is extended from a lower one side of the protrusion part 44 to an upper portion of the boundary surface 47.

3. The gas cylinder of claim 1, wherein said push support 50 includes:
a central through hole 51 that is inserted into the upper inner side of the cylinder 30 and supports the push bar 40 and prevents the gas of the interior of the cylinder 30 from being leaked to the outside wherein it has a cylindrical inner central part so that the circular rod part 42 of the push bar 40 passes through the same;
a receiving part 53 that is formed at an upper side of the central through hole 51 wherein the head part 41 of the push bar 40 is inserted thereinto and has a protrusion part insertion groove 52 into which the engaging protrusion part 48 of the push bar 40 is inserted;
an inner side o-ring insertion groove 54 that is formed in such a manner that the surrounding portion of the central through hole 51 of the lower surface is protruded;
an inner side o-ring 56 that is inserted into the inner side o-ring insertion groove 54 and has an inclined surface 55 for engaging a gas sealing force;
an outer side groove 57 that is formed at a surrounding portion of the outer side surface; and
an outer side o-ring 58 that is inserted into the outer side groove 57 and prevents the gas of the interior of the cylinder from being leaked to the outside, wherein the inner side o-ring 56 includes an inclined surface 55 inclined at a certain angle for blocking a gas movement between the chambers X and Y.

4. The gas cylinder of claim 1, wherein in said gas flow path pipe 70, the inner diameter of the inner central through hole 71 is larger than the outer is diameter of the concave part 46 of the push bar 40 and is less than the outer diameter of the circular rod part 42 of the push bar 40, and the outer diameter of the gas flow path pipe 70 is smaller than the central through hole 96 of the piston assembly 90, and the end surface of the upper side is opened, and the end surface 74 of the lower side is closed, and a gas flow path hole 73 is formed at an upper side of the lower side end surface 74, and a cylindrical pipe having a metallic bar 75 therein in a straight line shape is formed therein.

5. The gas cylinder of claim 1, wherein in said piston assembly 90, the piston part 81 and the piston rod part 91 are integrally injection-molded using an engineering plastic, and the gas flow path pipe 70 is installed at the inner center portions of the piston part 81 and the piston rod part 91 and reciprocates in the central through hole 96, and the smaller inner diameter portion is formed at the lower side of the central through hole 96 and is used as the gas injection through hole 99, and a gas flow hole 98 is formed at one side of the upper portion of the piston rod part 91; and
said piston part 81 includes an outer side groove 83 that is formed in a cylindrical shape and has the same diameter as the inner diameter of the cylinder 30 and is formed at a central portion of the outer surface; an elastic outer o-ring 87 that is inserted into the outer side groove 83 and has a gas sealing function between the chambers X and Y; a protrusion part 88 that is formed at one side of the upper rim portion of the central through hole 96; an inner side groove 86 formed by the protrusion part 88; an inner o-ring 84 that is inserted into the inner side groove 86 and has a gas sealing function; and a piston lid 85 that is engaged to the upper side of the protrusion part 88 and prevents an escape of the inner side o-ring 84 wherein the interior of the cylinder 30 is divided into the chambers X and Y, and when the cylinder 30 moves up, the gas passes through the inner o-ring 84 capable of performing the gas sealing function in such a manner that the gas flow hole 73 of the gas flow path pipe 70 is inserted into the inner side groove 86 of the piston part 81, and at the time when the gas is inserted into the interior of the chamber X, the gas flow path is closed, and the cylinder 30 stops moving-up; and
said piston rod part 91 includes a central through hole 96 that is integrally formed with the lower side of the piston part 81 and is longitudinally formed in a cylindrical shape and is formed at the inner center portion and receives a gas flow path pipe 70 therein; a gas injection through hole 99 of which narrow inner diameter is formed at a lower side of the central through hole 96; an inclined surface 94 formed at a boundary between the central through hole 96 and the gas injection hole 99; a gas flow hole 98 formed at one side of the upper portion wherein gas flows therein; and a clip insertion groove 97 formed at an outer surface of the end portion of the lower side wherein the end portion of the lower side having the clip insertion groove 97 has a smaller inner diameter for thereby being inserted into the central through hole of the spindle support 130, so that the right angle step surface 92 is formed.

6. The gas cylinder of claim 1, wherein said rod guide 110 is formed of a rigid material for being supported against a high pressure gas in the interior of the cylinder and includes a central through hole 113 formed at a center inner side in a cylindrical shape wherein the rod support member 115 is inserted thereinto, and an inner side groove 112 that is formed at an end rim portion of the upper side of the central through hole 113, and said rod support member 115 is inserted into the central through hole 113 of the rod guide 110 and is formed of a certain material smoother than the material of the piston rod part 91 so that scratches and damages are not generated at the outer diameter surface 93 of the piston rod part 91 during the up and down movements and includes a central through hole 118 into which the piston rod part 91 of the piston assembly 90 is inserted at the central inner side, and an outer side protrusion part 116 that is protruded from the upper side in a circular shape and is mounted on the inner side groove 112 of the rod support member 110.

7. The gas spring of claim 1, wherein said clip 160 is formed of a synthetic resin based on the injection molding method and includes a central through hole 162 formed so that a lower end of the piston rod part 91 passes through the central through hole 162, a protrusion 161 that is divided into multiple parts along an inner surface of the central through hole 162 and has a certain inclination in the direction of the center of the inner side through hole with a certain elastic force and is fixedly inserted into the clip insertion groove 97 of the piston rod part 91, and an outer surface rim 163 that performs a reinforcing role capable of supporting the protrusion 161.

8. A gas injection method into the interior of the cylinder 30 that is characterized in that a high pressure gas is forced into the chambers X and Y from the outside of the cylinder 30 that remains in the same gas pressure state as the atmospheric state, and a push bar 40 is pushed down in a downward direction “a” so that the inclined surface 55 of the inner side o-ring 56 is separated from the upper side end surface 72 of the gas flow path pipe 70 in a state that the gas pressure state in the chambers X and Y is the same as the atmospheric state, so that the gas flow path groove 43 allows a communication between the inner central through hole 71 of the gas flow path pipe 70 and the chamber X, and when a high pressure gas is forced into the interior of the cylinder 30 from the outside of the cylinder 30 through the gas injection through hole 99 of the piston rod part 91, the gas sealing part 95 is moved toward the lower side end surface 74 of the gas flow path pipe 70 of the piston rod part 91 by a high pressure gas and stops, and a gas injection through hole 99 is communicated with the central through hole 96, and the central through hole 96 is communicated with the chamber Y through the gas flow hole 98 formed at the boundary between the piston part 81 and the piston rod part 91, so that a high pressure gas is injected into the chamber Y of the interior of the cylinder based on a pressure difference between the gas pressure of the interior of the cylinder and the pressure of the gas injected from the outside of the cylinder 30, and the gas injected into the interior of the piston rod part 91 through the gas injection through hole 99 is inputted into the inner central through hole 71 of the gas flow path pipe 70 through the gas flow path hole 73 of the gas flow path pipe 70 and is moved in the upward direction and then is injected into the chamber X through the gas flow path groove 43 formed at the push bar 40, and when the gas pressure of the interior of the cylinder reaches at a certain pressure, the supply of the high pressure gas forced from the outside of the cylinder is stopped, and upon stopping the supply of the gas, the gas sealing part 95 inserted into the inner central through hole 96 of the piston assembly 90 is tightly contacted with the inclined surface 94 formed at the inner central through hole of the piston rod part 91 based on a high pressure gas in the interior of the cylinder 30, so that it is possible to prevent a high pressure gas in the interior of the cylinder from being leaked, whereby the gas injection into the interior of the cylinder 30 is completed.
